(19) United States
(12) Patent Application Publication
(10) Pub. No.: US 2026/0218838 A1
(43) Pub. Date: Jul. 30, 2026

(54) THERMAL INSULATION COVER, THERMAL INSULATION SYSTEM AND METHOD OF THERMALLY INSULATING A PILE OF SNOW OR GLACIER

(71) Applicant: SNOW SECURE OY, LEPPAVIRTA (FI)

(72) Inventors: Mikko MARTIKAINEN, Varkaus (FI); Matti MARTIKAINEN, Varkaus (FI); Henri NIEMINEN, Salo (FI)

(21) Appl. No.: 19/147,542

(22) PCT Filed: Jan. 13, 2023
(86) PCT No.: PCT/FI2023/050032

§ 371 Date: Jul. 11, 2025

(51) Int. Cl. F16L 59/02; E01H 4/00

(52) U.S. Cl. CPC F16L 59/029; E01H 4/00

(57) ABSTRACT

The thermal insulation cover (1) for thermally insulating a pile of snow (10) or a glacier comprises a thermal insulation layer (2), a waterproofing layer (3) made of a plastic material arranged on the top side of the thermal insulation layer (2), and a textile layer (4a, 4b, 4c, 4d) attached to the top side of the water-proofing layer (3), the textile layer (4a, 4b, 4c, 4d) functioning as the loop part of a hook-and-loop fastener and covering the waterproofing layer (3) at least at longitudinal edge regions of the thermal insulation cover (1), wherein a longitudinal edge region of the thermal insulation cover (1) can be arranged next to a second, similar, thermal insulation cover (1′) or to cover part of said second thermal insulation cover (1′) and attached to said second thermal insulation cover (1′) using an attachment strip (11) forming the hook part of said hook-and-loop fastener.

### TECHNICAL FIELD OF THE INVENTION

The present invention concerns a thermal insulation cover for thermally insulating a pile of snow or a glacier, as defined in claim 1. The invention also concerns a method of thermally insulating a pile of snow or a glacier, as defined in another independent claim. The invention further concerns a thermal insulation system for thermally insulating a pile of snow or a glacier.

### BACKGROUND OF THE INVENTION

To preserve snow over the summer, the snow must be covered with a sufficient amount of appropriate heat insulating materials since even the Nordic countries may experience outdoor temperatures up to +30° C. during the summer months. Besides, the insulation covering a snow storage is exposed to a lot of direct sunshine in the summer, and, in rainy weather, the snow storage is wet by rainwater.

The heat insulation of a snow storage comprises heat insulation material added on top of a snow mass piled up at a desired snow storage site. Application of thermal insulation boards such as polystyrene and/or polyurethane insulation boards has become more and more popular during recent years. This is because such solutions provide improved thermal insulation ability, better quality of preserved snow as well as it allows using the same insulation material for preserving snow several years, which makes such method also more affordable compared to the traditional snow storing methods such as saw dust insulation.

Typically a thermal insulation covering being made by applying insulation boards is formed by attaching plurality of insulation boards side by side adjacent to each other and one after another such that a substantially large insulation board mat (hereinafter “insulation covering section”) is obtained. The connections between the adjacent insulation boards are designed in a single insulation covering section such a way that they allow the adjacent insulation boards appropriately bend in respect of each other such that the insulation cover section will conform the shapes of a snow pile when it is laid on its position on the snow pile to be preserved.

However, for a huge pile of snow that is needed for e.g. properly snowing a single skiing slope, a great number of insulation boards are required. Thus, a whole insulation covering cannot be made from a single piece of continuous insulation covering. This is, among others, because of the safety reasons since if a single piece of the insulation covering is made too large it is very difficult and hazardous to handle, especially in a windy weather. Therefore, the thermal insulation covering of a snow storage that is made by applying insulation board mats has to be assembled by using several insulation covering sections, which will be attached to each other on the storage site where they are placed on the pile of the snow to be preserved.

A drawback of the presently known methods for providing thermal insulation coverings formed by applying insulation board mats is that the connecting methods applied in fastening the insulation covering sections to each other have not met the requirements and needs relating durability against hard whether conditions experienced in typical snow preserving sites. This has been considered to be because of the presently known seaming and/or attachment methods used in attaching the insulation covering sections to each other have been too weak and unreliable. Weakness and lack of reliability of the attachments and connections between the insulation covering sections have caused, among others, that the presently known thermal insulation coverings have not been capable to prevent water from entering behind the thermal insulation coverings during preserving period. The presently known methods for assembling thermal insulation coverings on to the pile of snow have been also considered laborious and time-consuming due to the solutions being applied in the connections and attachments between the insulation covering sections.

Recently, also glaciers have been protected from melting by using covers. Due to the large size of glaciers, the covers used at glaciers are typically simpler and cheaper than the thermal insulation covers used for preserving snow. The covers may be simply geotextiles having no real thermal insulation properties but providing some protection from direct sunlight. However, regarding the attachment of cover sections to each other, similar challenges are encountered as when insulating piles of snow.

### SUMMARY OF THE INVENTION

An object of the present invention is to provide an improved thermal insulation cover for thermally insulating a pile of snow or a glacier. Another object of the invention is to provide a thermal insulation system for thermally insulating a pile of snow or a glacier. A further object of the invention is to provide a method of thermally insulating a pile of snow or a glacier.

The thermal insulation cover according to the invention has a longitudinal direction and a lateral direction, a bottom side configured to face the pile of snow or glacier and a top side configured to face outwards. The thermal insulation cover comprises a thermal insulation layer configured to reduce heat conduction and/or heat radiation through the thermal insulation cover, a waterproofing layer arranged on the top side of the thermal insulation layer and attached to the thermal insulation layer directly or indirectly, the waterproofing layer being made of a plastic material and covering substantially the whole thermal insulation layer, and a textile layer attached to the top side of the waterproofing layer, the textile layer being configured to function as the loop part of a hook-and-loop fastener, the textile layer covering the waterproofing layer at least at longitudinal edge regions of the thermal insulation cover. The thermal insulation cover is configured such that a longitudinal edge region of the thermal insulation cover can be arranged next to a second, similar, thermal insulation cover or to cover part of said second thermal insulation cover and attached to said second thermal insulation cover using an attachment strip configured to form the hook part of said hook-and-loop fastener and to attach to the textile layers of said thermal insulation covers.

The thermal insulation cover according to the invention allows quick and reliable attachment of thermal insulation covers. The covers can be attached to each other releasably, thus allowing quick removal and reuse of the thermal insulation covers.

According to an embodiment of the invention, the waterproofing layer is configured to extend at least on one longitudinal side of the thermal insulation layer beyond the edge of the thermal insulation layer to form a skirt portion configured to cover part of said second thermal insulation cover. The skirt portion is beneficial in particular if the thermal insulation layer is thick. The skirt portion allows overlap of the adjacent thermal insulation covers and prevents rainwater from flowing underneath the thermal insulation covers. Due to the flexibility of the skirt portion, it also allows easier attachment of the adjacent thermal insulation covers.

According to an embodiment of the invention, the skirt portion extends 20-50 cm beyond the edge of the thermal insulation layer. Such a skirt portion allows sufficient overlap of thermal insulation covers and easy handling of the thermal insulation covers.

According to an embodiment of the invention, the textile layer covers the waterproofing layer at the lateral edge regions for allowing attachment of a separate skirt part to the thermal insulation cover. A separate skirt part protects the snow from direct sunshine and rain. When the thermal insulation covers do not need to extend to the ground, the thermal insulation covers are protected from dirt.

According to an embodiment of the invention, the textile layer covers only the edge regions, leaving a middle part of the waterproofing layer free. When the textile layer is configured to cover only part of the waterproofing layer, the thermal insulation cover is lighter and absorbs less water. Also, fouling of the thermal insulation cover is reduced.

According to an embodiment of the invention, the width of the textile layer at each longitudinal edge region is at least 30 cm. A sufficiently wide textile layer ensures reliable attachment. Also, the textile layer provides a less slippery surface, allowing safe working while mounting the thermal insulation covers.

According to an embodiment of the invention, the width of the textile layer at each longitudinal edge region is at most 80 cm. By keeping the textile layer narrow, the weight, water absorbance and fouling of the thermal insulation cover is reduced.

According to an embodiment of the invention, the width of the thermal insulation cover is 2.0-4.0 m. Such a width allow easy handling and quick mounting of the thermal insulation covers.

According to an embodiment of the invention, the waterproofing layer is made of ethylene-vinyl acetate. The use of EVA provides suitable properties, such as resistance to UV radiation and freeze.

According to an embodiment of the invention, the textile layer is attached to the layer beneath by gluing, sewing or by applying heat to the textile layer and/or to the layer beneath.

According to an embodiment of the invention, the thickness of the thermal insulation layer is at least 10 mm.

According to an embodiment of the invention, the thermal insulation layer comprises a plurality of insulation boards such that at least some of the insulation boards are pivotably connected to at least one adjacent insulation board in the longitudinal direction of the thermal insulation cover to allow folding of the thermal insulation cover. The use of insulation boards allows good thermal insulation and easy handling of the thermal insulation covers.

According to an embodiment of the invention, the thermal insulation layer comprises a top cover layer arranged on the top side of the insulation boards and a bottom cover layer arranged on the bottom side of the insulation boards, and the top cover layer and the bottom cover layer are attached to each other at predetermined locations to form pockets separated from each other along laterally extending lines, each pocket accommodating one or more insulation boards, the cover layers forming a pivot joint between the adjacent pockets. The cover layers protect the insulation boards and form a durable joint between the insulation boards.

According to an embodiment of the invention, the waterproofing layer is attached to the thermal insulation layer by point-form and/or line-form attachment such that slack is formed in the waterproofing layer to allow folding of the thermal insulation cover.

According to an embodiment of the invention, the waterproofing layer is attached to the thermal insulation layer by means of screws. The screws allow easy and reliable attachment of the waterproofing layer.

According to an embodiment of the invention, the thickness of the insulation boards is at least 30 mm.

According to an embodiment of the invention, the thermal insulation layer is made of a flexible material allowing rolling of the thermal insulation cover. A rollable thermal insulation cover is suitable in particular for applications where large areas need to be covered, such as for protecting glaciers.

According to an embodiment of the invention, the thermal insulation layer comprises an aluminum foil. An aluminum foil reflects effectively heat. The aluminum foil can form part of the thermal insulation layer. However, in some applications, the heat insulation layer could consists of an aluminum foil.

The thermal insulation system according to the invention comprises at least a first thermal insulation cover defined above and a second thermal insulation cover defined above configured to be arranged adjacent to said first thermal insulation cover, and at least one attachment strip that is configured to form the hook part of said hook-and-loop fastener for attaching an edge region of said first thermal insulation cover to an edge region of said second thermal insulation cover.

According to an embodiment of the invention, the system further comprises a separate skirt part made of a flexible sheet material and having a top surface that is at least partly configured to form the loop part of a hook-and-loop fastener, and a second attachment strip that is configured to form the hook part of a hook-and-loop fastener for attaching the skirt part to lateral edge regions of said thermal insulation covers.

The method according to the invention for thermally insulating a pile of snow or a glacier using a thermal insulation system defined above comprises the steps of arranging said first thermal insulation cover over the pile of snow or glacier, arranging said second thermal insulation cover over the pile of snow or glacier adjacent to said first thermal insulation cover, arranging an edge region of said first thermal insulation cover next to an edge region of said second thermal insulation cover or partly over said edge region of said second thermal insulation cover, and attaching said attachment strip to the textile layer of the edge region of said first thermal insulation cover and to the textile layer of the edge region of said second thermal insulation cover substantially in parallel with the longitudinal directions of said thermal insulation covers so as to attach said edge regions of said thermal insulation covers to each other.

According to an embodiment of the invention, the method comprises the step of attaching a skirt part defined above to lateral edge regions of said first thermal insulation cover and said second thermal insulation cover.

### BRIEF DESCRIPTION OF THE DRAWINGS

In the following, embodiments of the invention are described in more detail with reference to the appended drawings, in which

FIG. 1 shows schematically a pile of snow covered by a plurality of thermal insulation covers,

FIG. 2 shows partial cross-sectional view of two thermal insulation covers attached to each other,

FIG. 3 shows a top view of a thermal insulation cover according to an embodiment of the invention,

FIG. 4 shows a cross-sectional view of the thermal insulation cover of FIG. 3,

FIG. 5 shows a top view of three thermal insulation covers attached to each other,

FIG. 6 shows a cross-sectional side view of a thermal insulation cover according to an embodiment of the invention,

FIG. 7 shows a cross-sectional side view of a thermal insulation cover according to another embodiment of the invention,

FIG. 8 shows one way of attaching different layers of the thermal insulation cover to each other, and

FIG. 9 shows as a flow chart the method according to the invention.

### DETAILED DESCRIPTION OF EMBODIMENTS OF THE INVENTION

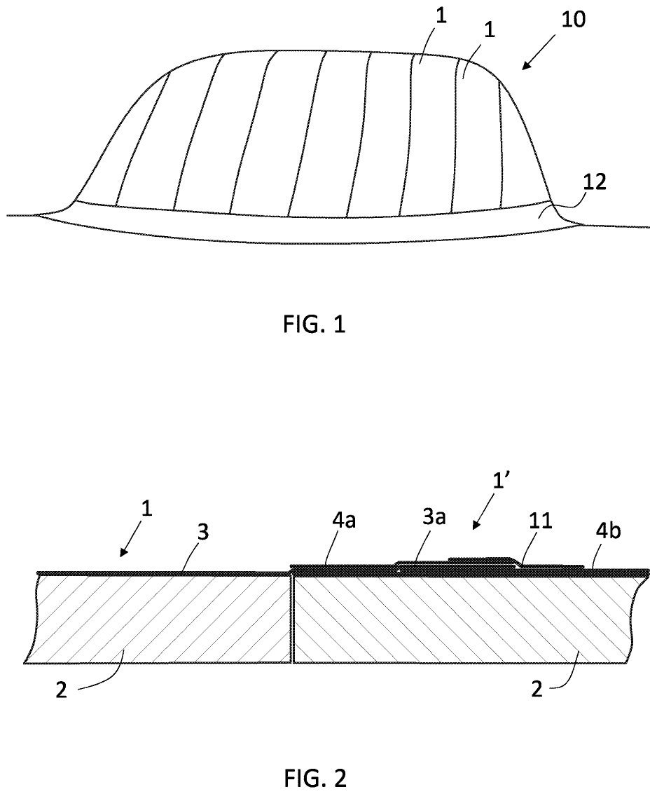

FIG. 1 shows schematically a pile of snow 10 that has been insulated using a plurality of thermal insulation covers 1. The thermal insulation covers 1 are elongated mats. The thermal insulation cover 1 has a longitudinal direction, a lateral direction, a bottom side and a top side. The bottom side is configured to face the pile of snow 10 and the top side is configured to face outwards. The width of the thermal insulation cover 1 can be, for instance, 2.0-4.0 m. However, the width could also be different. In the longitudinal direction the length of the thermal insulation cover 1 can be substantially greater, for instance at least 10 m. The number of thermal insulation covers 1 used for insulating the pile of snow 10 depends on the size of the pile of snow 10 and the dimensions of the thermal insulation covers 1. Each thermal insulation cover 1 is configured to be attached to the adjacent thermal insulation covers 1 on the longitudinal sides of the thermal insulation cover 1. In addition, each end or at least one end of the thermal insulation cover 1 could be configured to allow attaching the thermal insulation cover 1 from its end to a similar thermal insulation cover 1. A thermal insulation system can thus be formed by connecting several thermal insulation covers 1 to each other to form a continuous cover.

Different views of different embodiments of the invention are shown in FIGS. 2-8.

Heat can be transferred by conduction, convection and radiation. To reduce heat transfer, the thermal insulation cover 1 comprises a thermal insulation layer 2. The thermal insulation layer 2 can be configured to reduce in particular heat conduction and/or heat radiation through the thermal insulation cover 1. The thermal insulation layer 2 can consist of a layer that is configured to reduce heat radiation, but does not significantly reduce heat conduction. The thermal insulation layer 2 could thus consist of, for instance, an aluminum foil. However, the thermal insulation layer 2 preferably comprises material having low thermal conductivity to reduce also heat conduction. The heat conduction properties of materials can be characterized by so called lambda value. The thermal insulation layer 2 can comprise material having a lambda-value λ of less than 0.3 W/(m·K), preferably less than 0.05 W/(m·K). The thermal insulation layer 2 can comprise, for instance, expanded polystyrene (EPS), extruded polystyrene (XPS) or cellular plastic.

The thermal insulation properties of the thermal insulation layer 2 also depend on the thickness of the thermal insulation layer 2. The thickness of the thermal insulation layer 2 could be in the range of 2-150 mm. However, in particular if the purpose of the thermal insulation layer 2 is to primarily reduce heat radiation, the thermal insulation layer 2 could be thinner. Thermal transmittance through a structure can be characterized by a U-value. The U-value of the thermal insulation layer 2 is preferably less than 1.0 W/(m²·K). The thermal insulation layer 2 can comprise several layers. For instance, the thermal insulation layer 2 could comprise one or more layers made of a material having a low lambda-value and one or more layers configured to reflect heat radiation. For instance, the thermal insulation layer 2 can comprise a layer made of XPS, and on one or both sides of the XPS layer a layer made of an aluminum foil. The thermal insulation layer 2 can also comprise one or more layers protecting any thermal insulation materials.

The thermal insulation cover 1 further comprises a waterproofing layer 3 that is arranged on the top side of the thermal insulation layer 2. In the use position of the thermal insulation cover 1, the waterproofing layer 3 is thus above the thermal insulation layer 2. The waterproofing layer 3 is attached to the thermal insulation layer 2. The waterproofing layer 3 can be attached to the thermal insulation layer 2 either directly or indirectly. There could thus be further layers between the thermal insulation layer 2 and the waterproofing layer 3, or the waterproofing layer 3 can be arranged directly on the thermal insulation layer 2. The waterproofing layer 3 is made of a plastic material. A suitable material is ethylene-vinyl acetate (EVA). However, the waterproofing layer 3 could also be made of some other suitable material that is impermeable to water. The waterproofing layer 3 covers substantially the whole thermal insulation layer 2. However, it is possible that the waterproofing layer 3 does not extend on all sides of the thermal insulation cover 1 to the edges of the thermal insulation layer 2. For instance, if the thermal insulation cover 1 is configured to overlap with an adjacent thermal insulation cover 1, part of the area that is intended to be placed under the adjacent thermal insulation cover 1 could be without the waterproofing layer 3.

The thermal insulation cover 1 further comprises a textile layer 4a, 4b, 4c, 4d attached to the top side of the waterproofing layer 3. The textile layer 4a, 4b, 4c, 4d is configured to function as the loop part of a hook-and-loop fastener and covers the waterproofing layer 3 at least at longitudinal edge regions of the thermal insulation cover 1. The thermal insulation cover 1 is configured such that a longitudinal edge region of the thermal insulation cover 1 can be arranged next to a similar adjacent thermal insulation cover 1 or to cover part of the adjacent thermal insulation cover 1 and attached to the adjacent thermal insulation cover 1 using an attachment strip 11 that is configured to form the hook part of the hook-and-loop fastener.

The textile layer 4a, 4b, 4c, 4d of the thermal insulation cover 1 and the attachment strip 11 thus form parts of a Velcro-type fastener. That allows a simple, quick and reliable attachment of two adjacent thermal insulation covers 1. The thermal insulation covers 1 can also be easily detached from each other for removing the thermal insulation covers 1 and storing them for reuse. In the embodiments of the figures, the textile layer 4a, 4b, 4c, 4d covers the waterproofing layer 3 also at lateral edge regions of the thermal insulation cover 1, i.e. at the ends of the thermal insulation cover 1. The textile layer comprises longitudinal portions 4a, 4b and lateral portions 4c, 4d. The lateral portions 4c, 4d of the textile layer at the ends of the thermal insulation cover 1 allow attachment of a separate skirt part 12 to the thermal insulation cover 1.

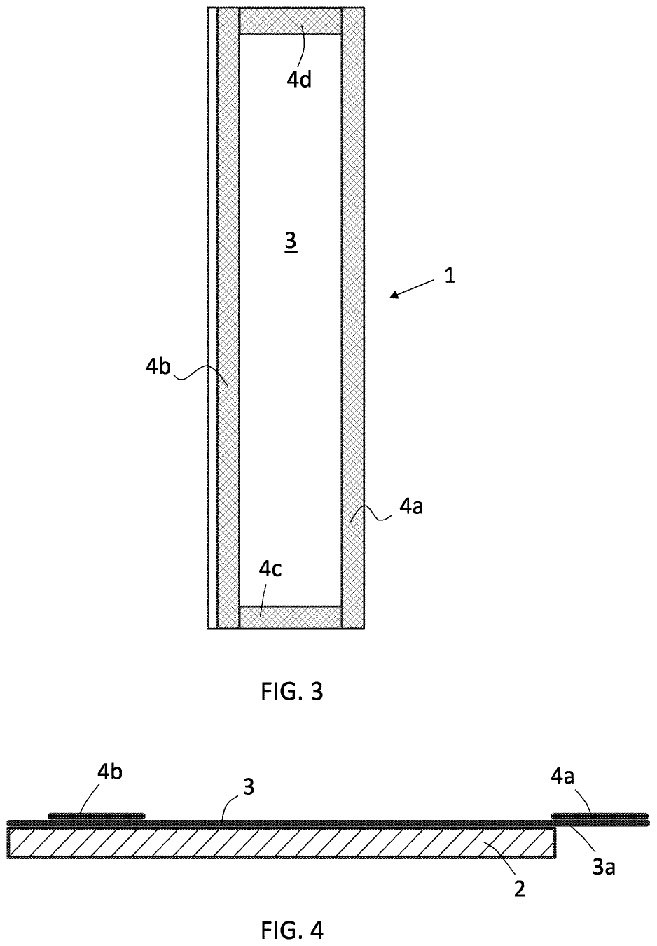

Preferably, the textile layer 4a, 4b, 4c, 4d covers only the edge regions, leaving a middle part of the waterproofing layer 3 free, as shown in FIG. 3. The textile layer 4a, 4b, 4c, 4d absorbs water and is more easily fouled than the waterproofing layer 3. Also, the textile layer 4a, 4b, 4c, 4d increases the weight of the thermal insulation cover 1. By arranging the textile layer 4a, 4b, 4c, 4d at the edge regions only, the handling of the thermal insulation cover 1 is easier and the thermal insulation cover 1 is easier to keep clean.

The width of the textile layer 4a, 4b, 4c, 4d at each longitudinal edge region can be, for instance, in the range of 30-80 cm. The textile layer 4 is less slippery than the waterproofing layer 3 and allows safe working when the thermal insulation covers 1 are being mounted and attached to each other.

The textile layer 4a, 4b, 4c, 4d can be attached to the waterproofing layer 3 or other layer beneath the textile layer 4a, 4b, 4c, 4d by gluing, or by applying heat to the textile layer 4a, 4b, 4c, 4d or to the layer beneath. Alternatively, the textile layer 4a, 4b, 4c, 4d could be sewn to the layer beneath.

The textile layer 4a, 4b, 4c, 4d can be made of a geotextile or other suitable material.

In the embodiments of the figures, the waterproofing layer 3 is configured to extend at least on one longitudinal side of the thermal insulation layer 2 beyond the edge of the thermal insulation layer 2 to form a skirt portion 3a. The skirt portion 3a can extend, for instance, 20-50 cm beyond the edge of the thermal insulation layer 2. The skirt portion 3a is configured to cover part of the adjacent thermal insulation cover 1. If the waterproofing layer 3 forms a skirt portion 3a, the textile layer 4a, 4b, 4c, 4d on the opposite longitudinal edge region of the thermal insulation cover 1 does not need to extend to the edge of the waterproofing layer 3, but the textile layer 4a, 4b, 4c, 4d can be arranged at a distance from the edge, as shown in the figures.

FIG. 2 shows a cross-sectional view of two thermal insulation covers 1, 1′. The thermal insulation cover 1 on the left is hereinafter referred to as a first thermal insulation cover and the thermal insulation cover 1′ on the right is referred to as a second thermal insulation cover. The thermal insulation covers 1, 1′ are arranged such that the thermal insulation layer 2 of the first thermal insulation cover 1 abuts the thermal insulation layer 2 of the second thermal insulation cover 1′. For effective thermal insulation, it is preferable to arrange the thermal insulation covers 1, 1′ as close to each other as possible. However, it is not necessary that the thermal insulation layers 2 abut each other. There could thus be a small gap between the thermal insulation layers 2 of the adjacent thermal insulation covers 1, 1′. The skirt portion 3a of the first thermal insulation cover 1 has been arranged on the second thermal insulation cover 1′.

The longitudinal textile layer portion 4b on the left side of the second thermal insulation cover 1′ is partly below the skirt portion 3a of the first thermal insulation cover 1. However, part of the longitudinal textile layer portion 4b is outside of the area covered by the skirt portion 3a and runs in parallel with the longitudinal edge of the skirt portion 3a. The longitudinal textile layer portion 4a on the skirt portion 3a of the first thermal insulation cover 1 extends to the longitudinal edge of the skirt portion 3a.

For attaching the skirt portion 3a of the first thermal insulation cover 1 to the second thermal insulation cover 1′, an attachment strip 11 is provided. The attachment strip 11 is configured to form the hook part of a hook-and-loop fastener 11. The attachment strip 11 is attached to the longitudinal textile layer portion 4a of the skirt part 3a of the first thermal insulation cover 1 and to the longitudinal textile layer portion 4b of the second thermal insulation cover 1′ at the edge region located on one of the longitudinal sides of the first thermal insulation cover 1. The width of the attachment strip 11 can be, for instance, in the range of 10-20 cm. Approximately half of the attachment strip 11 can be attached to the first thermal insulation cover 1 and the other half to the second thermal insulation cover 1′. The attachment strip 11 could be stored as a roll and rolled out for attaching it to the respective textile layer portions 4a, 4b of the thermal insulation covers 1, 1′.

More than one attachment strips 11 can be used for attaching two insulation covers 1 to each other. The attachment strips 11 could thus be shorter than the thermal insulation covers 1. If two thermal insulation covers 1 are attached to each other from their ends, a single attachment strip 11 could be used for attaching several thermal insulation covers 1 to each other from their longitudinal edges.

Preferably, the textile layer 4a, 4b, 4c, 4d is made wider than the width of half of the attachment strip 11 at least at the longitudinal edge region covered by the skirt portion 3a of the adjacent thermal insulation cover 1. When the skirt portion 3a is attached to the textile layer portion 4b, part of the textile layer portion 4b is left free. This allows safe walking on the pile of snow 10.

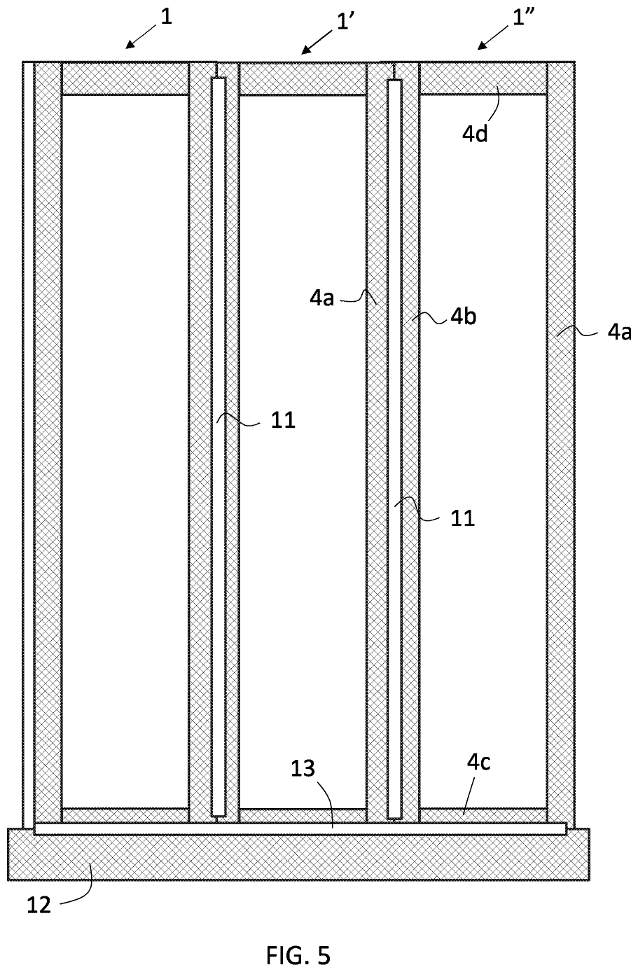

FIG. 5 shows a top view of three thermal insulation covers 1, 1′, 1″. Each thermal insulation cover 1, 1′, 1″ is attached to the adjacent thermal insulation covers 1, 1′, 1″ in the manner described above.

In step 101 of the method according to the invention, the first thermal insulation cover 1 is arranged over the pile of snow 10. In step 102, the second thermal insulation cover 1′ is arranged over the pile of snow 10 next to the first thermal insulation cover 1. In step 103, an edge region of the first thermal insulation cover 1 is arranged next to an edge region of the second thermal insulation cover 1′ or partly over the edge region of the second thermal insulation cover 1′. In step 104, the attachment strip 11 is attached to the textile layer 4a, 4b, 4c, 4d of the edge region of the first thermal insulation cover 1 and to the textile layer 4a, 4b, 4c, 4d of the edge region of the second thermal insulation cover 1′ substantially in parallel with the longitudinal directions of the thermal insulation covers 1, 1′ so as to attach the edge regions to each other. Further thermal insulation covers are installed in a similar way. It should be noted that the steps do not need to be carried out in the order described above. For instance, when installing a plurality of thermal insulation covers 1, all the thermal insulation covers 1 could be first pulled over the pile of snow 10, then the skirt portions 3a could be arranged in place, and last all the attachment strips 11 could be attached. The process would be similar for protecting a glacier.

FIGS. 1 and 5 show a skirt part 12 for a thermal insulation system. The skirt part 12 is a separate part that can be attached to the thermal insulation covers 1 in a similar way as the thermal insulation covers 1 are attached to each other. At least part of the skirt part 12 has thus a textile layer as an uppermost layer. The skirt part 12 can consist of a textile layer. The skirt part 12 could thus be made of a geotextile. Alternatively, the skirt part 12 could comprise a waterproofing layer and a textile layer at least party covering the upper surface of the waterproofing layer. The skirt part 12 could also comprise a thermal insulation layer, but that is not necessary. If the skirt part 12 comprises a thermal insulation layer, the thermal insulation layer is preferably thinner than the thermal insulation layer 2 of the thermal insulation covers 1. For instance, the thermal insulation layer of the skirt part 12 could consist of an aluminum foil.

The purpose of the skirt part 12 is to cover the lower part of the pile of snow 10. The thermal insulation covers 1 can thus be shorter such that they do not extend to the ground. This protects the thermal insulation covers 1 from dirt. FIG. 5 shows how the skirt part 12 has been attached to the thermal insulation covers 1, 1′, 1″ by means of a second attachment strip 13. The second attachment strip 13 can be identical to the attachment strips 11 used for attaching the thermal insulation covers 1, 1′, 1″ to each other. FIG. 5 shows a skirt part 12 only at one end of the insulation covers 1, 1′, 1″, but preferably the skirt part 12 encircles the whole pile of snow 10. Even the other end of the insulation covers 1, 1′, 1″ can thus be provided with a skirt part 12. The skirt part 12 can comprise two or more shorter sections. The sections can be attached to each other from their ends using similar attachment strips 11, 13 as those used for attaching the insulation covers 1, 1′, 1″ to each other or the skirt part 12 to the insulation covers 1, 1′, 1″.

In the embodiments of the figures, the thermal insulation layer 2 comprises a plurality of insulation boards 5. At least some of the insulation boards 5 are pivotably connected to at least one adjacent insulation board 5 in the longitudinal direction of the thermal insulation cover 1 to allow folding of the thermal insulation cover 1. When the thermal insulation cover 1 is not in use, it can thus be folded to allow convenient storing of the thermal insulation cover 1.

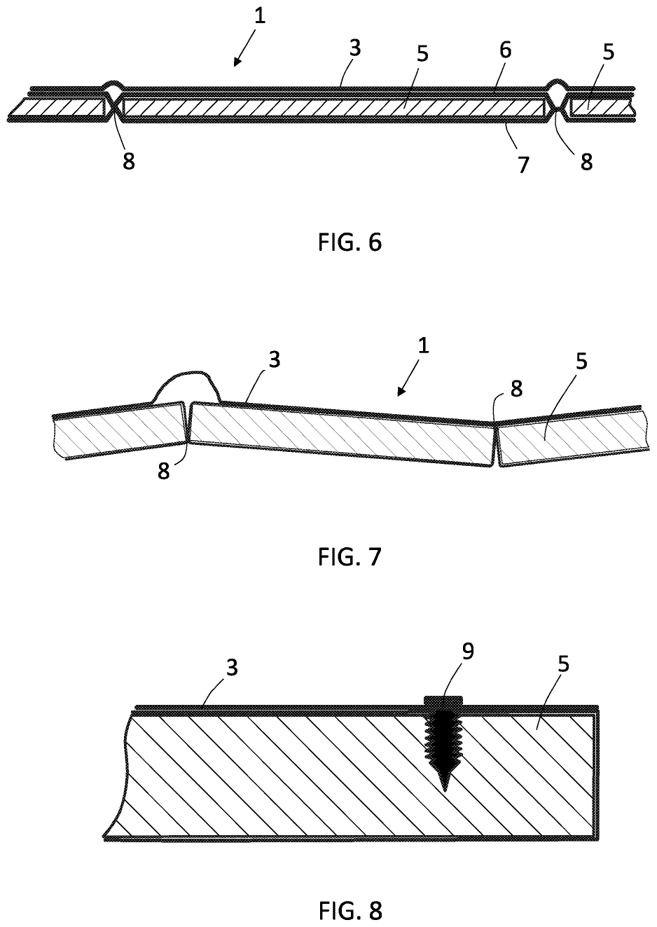

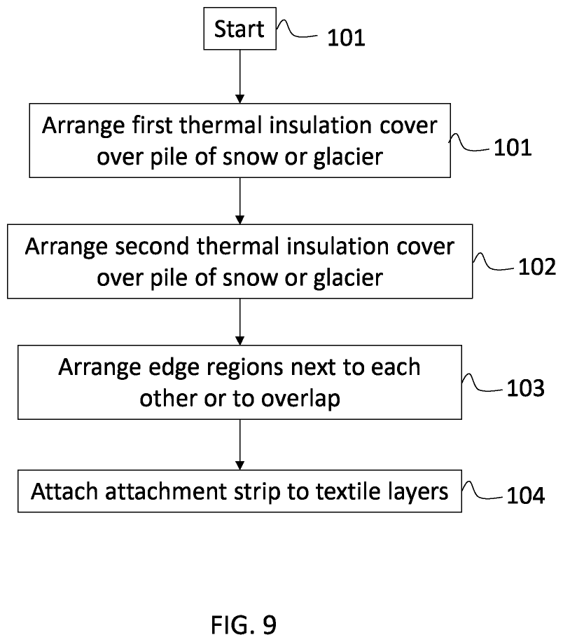

FIG. 6 shows an embodiment, where the thermal insulation layer 2 comprises a top cover layer 6 arranged on the top side of the insulation boards 5 and a bottom cover layer 7 arranged on the bottom side of the insulation boards 5. The top cover layer 6 and the bottom cover layer 7 are attached to each other at predetermined locations to form pockets that are separated from each other along laterally extending lines. Each pocket accommodates one or more insulation boards 5. The insulation boards 5 can be made of, for instance, XPS. The thickness of the insulation boards 5 is preferably at least 20 mm, more preferably at least 40 mm. Thicker insulation boards 5 improve insulation, but make the handling and storing of the thermal insulation covers 1 more difficult. The thickness of the thermal insulation boards 5 is therefore preferably at most 120 mm.

The cover layers 6, 7 form a pivot joint 8 between the adjacent pockets. The cover layers 6, 7 can be attached to each other for example by sewing, welding or gluing to form the pivot joints 8. The ends of the pockets on the longitudinal sides of the thermal insulation cover 1 can be closed in a similar manner. Each pocket can be provided with one, two or more insulation boards 5. For instance, each pocket could accommodate four insulation boards arranged in a square-formation. Each pocket could also accommodate two or more thinner insulation boards 5 arranged on top of each other. The pockets are preferable dimensioned such that significant moving of the insulation boards 5 within the pockets is prevented. The insulation boards can be made of, for instance, extruded polystyrene. The ends of the pockets can be closed in a suitable manner, such as by means of screws, welding, sewing or gluing. For the sake of clarity, the textile layer is not shown in FIG. 6.

The top and bottom cover layers 6, 7 can be made of a suitable plastic material, such as polyvinyl chloride (PVC). The top and bottom cover layers 6, 7 are not necessary, but the thermal insulation layer 2 could consist of the insulation boards 5 or could comprise only one of the cover layers 6, 7. If the thermal insulation layer 2 does not comprise any cover layers, the insulation boards 5 could be attached to each other in some other way. For instance, two adjacent insulation boards 5 could be attached to each other by means of a strip of flexible material that is attached to both insulation boards 5 to form a pivot joint. The flexible material could be attached to the insulation boards 5 by gluing or welding or by means of mechanical fasteners, such as screws.

FIG. 6 also shows the waterproofing layer 3. The waterproofing layer 3 is attached to the thermal insulation layer 2 such that slack is formed in the waterproofing layer 3 to allow folding of the thermal insulation cover 1. The slack of the waterproofing layer 3 also prevents rainwater from flowing into the pivot joints 8 and via the pivot joints 8 underneath the thermal insulation cover 1. The waterproofing layer 3 can be attached to the thermal insulation layer 2 for instance by means of screws 9, as shown in FIG. 8, or by means of other point-form attachment. Alternatively, the waterproofing layer 3 could be attached to the thermal insulation layer 2 by line-form attachment, such as by means of elongated welds.

The embodiment of FIG. 7 is similar to the embodiment of FIG. 6. However, the pivot joints 8 are formed alternately on opposite sides of the insulation boards 5. Every other pivot joint 8 is thus formed on the bottom side of the insulation boards 5 and every other pivot joint 8 is formed on the top side of the insulation boards 5. This allows a smaller gap between the adjacent pockets. Similar pivot joints 8 could be formed by strips of flexible material attached alternately to the top sides and bottom sides of the adjacent insulation boards 5. In the embodiment of FIG. 7, the waterproofing layer 3 needs to be provided with slack only in the joints where the pivot joint 8 is formed on the bottom sides of the insulation boards 5. If the pivot joint 8 is at the level of the top of the thermal insulation layer 2, the waterproofing layer 3 does not prevent folding of the thermal insulation cover 1 and water flowing along the pivot joint 8 does not cause problems.

The embodiments of the figures show thermal insulation covers 1 with insulation boards 5. In the embodiments of the figures, the thermal insulation covers are foldable. However, the thermal insulation layer 2 could be made of a flexible material allowing rolling of the thermal insulation cover 1. For instance, the thermal insulation layer 2 could consist of an aluminum foil, or it could comprise cellular plastic. The aluminum foil or other insulating material could be arranged between a pair of waterproofing layers that could be made of a plastic material, such as EVA. Such a thermal insulation cover would be suitable in particular for protecting glaciers from melting during summer time. The thickness of a rollable thermal insulation cover 1 could be, for instance, in the range of 2-50 mm, preferably 10-30 mm. The thermal insulation cover 1 could be even thinner, if the purpose of the cover is to mainly reduce heat radiation through the thermal insulation cover 1. A cover with a thickness of over 50 mm is difficult to handle.

If the thermal insulation layer 2 is thin, for instance at most 30 mm, the skirt portion 3a is not necessary. The waterproofing layer 3 could thus have the same size as the thermal insulation layer 2. The thermal insulation covers 1 could be arranged next to each other such that their edges abut each other. Alternatively, a thermal insulation cover 1 could be arranged to partly overlap the adjacent thermal insulation cover 1.

1. A thermal insulation cover (1) for thermally insulating a pile of snow (10) or a glacier, the thermal insulation cover (1) having a longitudinal direction and a lateral direction, a bottom side configured to face the pile of snow (10) or glacier and a top side configured to face outwards, the thermal insulation cover (1) comprising
a thermal insulation layer (2) configured to reduce heat conduction and/or heat radiation through the thermal insulation cover (1),
a waterproofing layer (3) arranged on the top side of the thermal insulation layer (2) and attached to the thermal insulation layer (2) directly or indirectly, the waterproofing layer (3) being made of a plastic material and covering substantially the whole thermal insulation layer (2), and
a textile layer (4a, 4b, 4c, 4d) attached to the top side of the waterproofing layer (3), the textile layer (4a, 4b, 4c, 4d) being configured to function as the loop part of a hook-and-loop fastener and covering the waterproofing layer (3) at least at longitudinal edge regions of the thermal insulation cover (1),
wherein the thermal insulation cover (1) is configured such that a longitudinal edge region of the thermal insulation cover (1) can be arranged next to a second, similar, thermal insulation cover (1′) or to cover part of said second thermal insulation cover (1′) and attached to said second thermal insulation cover (1′) using an attachment strip (11) configured to form the hook part of said hook-and-loop fastener and to attach to the textile layers (4a, 4b, 4c, 4d) of said thermal insulation covers (1, 1′).

2. A thermal insulation cover (1) according to claim 1, wherein the waterproofing layer (3) is configured to extend at least on one longitudinal side of the thermal insulation layer (2) beyond the edge of the thermal insulation layer (2) to form a skirt portion (3a) configured to cover part of said second thermal insulation cover (1′).

3. A thermal insulation cover (1) according to claim 2, wherein the skirt portion (3a) extends 20-50 cm beyond the edge of the thermal insulation layer (2).

4. A thermal insulation cover (1) according to any of claims 1-3, wherein the textile layer (4a, 4b, 4c, 4d) covers the waterproofing layer (3) at lateral edge regions for allowing attachment of a separate skirt part (12) to the thermal insulation cover (1).

5. A thermal insulation cover (1) according to any of the preceding claims, wherein the textile layer (4a, 4b, 4c, 4d) covers only the edge regions of the waterproofing layer (3), leaving a middle part of the waterproofing layer (3) free.

6. A thermal insulation cover (1) according to any of the preceding claims, wherein the width of the textile layer (4a, 4b, 4c, 4d) at each longitudinal edge region is at least 30 cm.

7. A thermal insulation cover (1) according to any of the preceding claims, wherein the width of the textile layer (4a, 4b, 4c, 4d) at each longitudinal edge region is at most 80 cm.

8. A thermal insulation cover (1) according to any of the preceding claims, wherein the width of the thermal insulation cover (1) is 2.0-4.0 m.

9. A thermal insulation cover (1) according to any of the preceding claims, wherein the waterproofing layer (3) is made of ethylene-vinyl acetate.

10. A thermal insulation cover (1) according to any of the preceding claims, wherein the textile layer (4a, 4b, 4c, 4d) is attached to the layer beneath by gluing, sewing or by applying heat to the textile layer (4a, 4b, 4c, 4d) and/or to the layer beneath.

11. A thermal insulation cover (1) according to any of the preceding claims, wherein the thickness of the thermal insulation layer (2) is at least 10 mm.

12. A thermal insulation cover (1) according to any of the preceding claims, wherein the thermal insulation layer (2) comprises a plurality of insulation boards (5) such that at least some of the insulation boards (5) are pivotably connected to at least one adjacent insulation board (5) in the longitudinal direction of the thermal insulation cover (1) to allow folding of the thermal insulation cover (1).

13. A thermal insulation cover (1) according to claim 12, wherein the thermal insulation layer (2) comprises a top cover layer (6) arranged on the top side of the insulation boards (5) and a bottom cover layer (7) arranged on the bottom side of the insulation boards (5), and the top cover layer (6) and the bottom cover layer (7) are attached to each other at predetermined locations to form pockets separated from each other along laterally extending lines, each pocket accommodating one or more insulation boards (5), the cover layers (6, 7) forming a pivot joint (8) between the adjacent pockets.

14. A thermal insulation cover (1) according to claim 12 or 13, wherein the waterproofing layer (3) is attached to the thermal insulation layer (2) by point-form and/or line-form attachment such that slack is formed in the waterproofing layer (3) to allow folding of the thermal insulation cover (1).

15. A thermal insulation cover (1) according to any of claims 12-14, wherein the waterproofing layer (3) is attached to the thermal insulation layer (2) by means of screws (9).

16. A thermal insulation cover (1) according to any of claims 12-15, wherein the thickness of the insulation boards (5) is at least 30 mm.

17. A thermal insulation cover (1) according to any of claims 1-11, wherein the thermal insulation layer (2) is made of a flexible material allowing rolling of the thermal insulation cover (1).

18. A thermal insulation cover (1) according to any of the preceding claims, wherein the thermal insulation layer (2) comprises an aluminum foil.

19. A thermal insulation system for thermally insulating a pile of snow (10) or a glacier, the thermal insulation system comprising at least a first thermal insulation cover (1) according to any of the preceding claims and a second thermal insulation cover (1′) according to any of the preceding claims configured to be arranged adjacent to said first thermal insulation cover (1), and at least one attachment strip (11) that is configured to form the hook part of said hook-and-loop fastener for attaching an edge region of said first thermal insulation cover (1) to an edge region of said second thermal insulation cover (1′).

20. A thermal insulation system according to claim 19, wherein the system further comprises a separate skirt part (12) made of a flexible sheet material and having a top surface that is at least partly configured to form the loop part of a hook-and-loop fastener, and a second attachment strip (13) that is configured to form the hook part of a hook-and-loop fastener for attaching the skirt part (12) to lateral edge regions of said thermal insulation covers (1, 1′).

21. A method of thermally insulating a pile of snow (10) or a glacier using a thermal insulation system according to claim 19 or 20, the method comprising the steps of
arranging said first thermal insulation cover (1) over the pile of snow (10) or glacier (101),
arranging said second thermal insulation cover (1′) over the pile of snow (10) or glacier next to said first thermal insulation cover (1) (102),
arranging an edge region of said first thermal insulation cover (1) next to an edge region of said second thermal insulation cover (1′) or partly over said edge region of said second thermal insulation cover (1′) (103), and
attaching said attachment strip (11) to the textile layer (4a, 4b, 4c, 4d) of the edge region of said first thermal insulation cover (1) and to the textile layer (4a, 4b, 4c, 4d) of the edge region of said second thermal insulation cover (1′) substantially in parallel with the longitudinal directions of said thermal insulation covers (1, 1′) so as to attach said edge regions of said thermal insulation covers (1, 1′) to each other (104).

22. A method according to claim 21, wherein the thermal insulation system is according to claim 20 and the method comprises the step of attaching said skirt part (12) to lateral edge regions of said first thermal insulation cover (1) and said second thermal insulation cover (1,1′).
